(19) United States
(12) Patent Application Publication
(10) Pub. No.: US 2005/0007688 A1
(43) Pub. Date: Jan. 13, 2005

(54) Dual speed control to reduce audible noise and protect head during unload in ramp load drives with pawl latch

(76) Inventors: Joseph Chang, San Jose, CA (US); Ramin Monajemy, Santa Clara, CA (US)

Correspondence Address: IRELL & MANELLA LLP, 840 NEWPORT CENTER DRIVE, SUITE 400, NEWPORT BEACH, CA, 92660, US

(21) Appl. No.: 10/812,613

(22) Filed: Mar. 29, 2004

Related U.S. Application Data
(60) Provisional application No. 60/486,086, filed on Jul. 9, 2003.

(51) Int. Cl. G11B 21/02

(52) U.S. Cl. 360/75

(57) ABSTRACT

A hard disk drive that controls the movement of a head to an off-disk position while minimizing impact between an actuator arm and a crash stop of the drive. The disk drive includes a control circuit that can perform an off-disk routine that moves the head from a middle diameter to an outer diameter of the disk. Movement of the head across the disk can be accomplished with feedback information from Gray codes of the disk, or a back emf of the voice coil motor that moves the actuator arm. The head is then decelerated as the actuator arm moves toward the crash stop. This deceleration minimizes the impact between the actuator arm and the stop.

### REFERENCE TO CROSS-RELATED APPLICATIONS

This application claims priority to provisional Application No. 60/486,086 filed on Jul. 9, 2003.

### BACKGROUND OF THE INVENTION

1. Field of the Invention

The present invention relates to a technique for off loading a head from a disk while minimizing impact between an actuator arm and a crash stop.

2. Background Information

Hard disk drives contain a plurality of magnetic heads that are coupled to rotating disks. The heads write and read information by magnetizing and sensing the magnetic fields of the disk surfaces, respectively.

Each head is mounted to a flexure that is attached to an actuator arm. The actuator arm has a voice coil motor that can move the heads across the surfaces of the disks. Each head has an air bearing surface that cooperates with an air flow generated by the rotating disk to create an air bearing. The air bearings prevent mechanical wear between the heads and the disks.

The disk drive may be subjected to external shock loads that cause the heads to “slap” the disk. For example, the disk drive may be assembled into a portable computer that is dropped by an end user. The shock associated with dropping the computer may cause the heads to initially deflect away from the disks and then rebound in the opposite direction to strike the disk surfaces. Such a phenomenon is typically referred to as head slapping.

To minimize the occurrences of head slapping the heads of a disk drive are typically moved away from the data sections of the disks when not reading or writing information. In some disk drives the heads are “parked” on a ramp adjacent to the outer diameter of the disk.

Hard disk drives are sometimes exposed to rotational acceleration that can suddenly swing the actuator arm and cause internal damage to the drive. Some disk drives contain crash stops that can limit the movement of the actuator arm within the hard disk area. The actuator arms can then be latched in place to prevent any further undesirable movement of the arm.

The assignee of this application, Samsung Electronics, Co., Ltd. has sold a disk drive that contains an integral crash stop and latch. The crash stop portion of the latch engages a corresponding latch portion of the actuator arm every time the heads are off-loaded from the disks. The crash stop/latch is constructed from a metal material. Unfortunately, the disk drive emits a metallic popping sound each time the actuator arm contacts the crash stop. This may occur during power down routines of the computer that contains the drive, a routine that is relatively frequent for laptop computers. The popping sound can be annoying and/or lead the user to believe that the drive is defective. It would be desirable to minimize impact of the actuator arm with a crash stop during an off-disk routine.

### BRIEF SUMMARY OF THE INVENTION

A hard disk drive that has a head coupled to an actuator arm. The disk drive also includes a control circuit that can control movement of the head across a disk and then decelerate movement of the head as the actuator moves into contact with a crash stop.

### BRIEF DESCRIPTION OF THE DRAWINGS

FIG. 1 is a top view of an embodiment of a hard disk drive of the present invention;

FIG. 2 is a schematic of an electrical system of the hard disk drive;

FIG. 3 is an illustration of an embodiment of an off-disk routine moving the heads of the disks onto a ramp;

FIG. 4 is an illustration similar to FIG. 3 showing another embodiment of an off-disk routine;

FIG. 5 is an illustration similar to FIG. 3 showing another embodiment of an off-disk routine.

### DETAILED DESCRIPTION

Disclosed is a hard disk drive that controls the movement of a head to an off-disk position while minimizing impact between an actuator arm and a crash stop of the drive. The disk drive includes a control circuit that can perform an off-disk routine that moves the head from a middle diameter to an outer diameter of the disk. Movement of the head across the disk can be accomplished with feedback information from Gray codes of the disk, or a back emf of the voice coil motor that moves the actuator arm. The head is then decelerated as the actuator arm moves toward the crash stop. This deceleration minimizes the impact between the actuator arm and the stop.

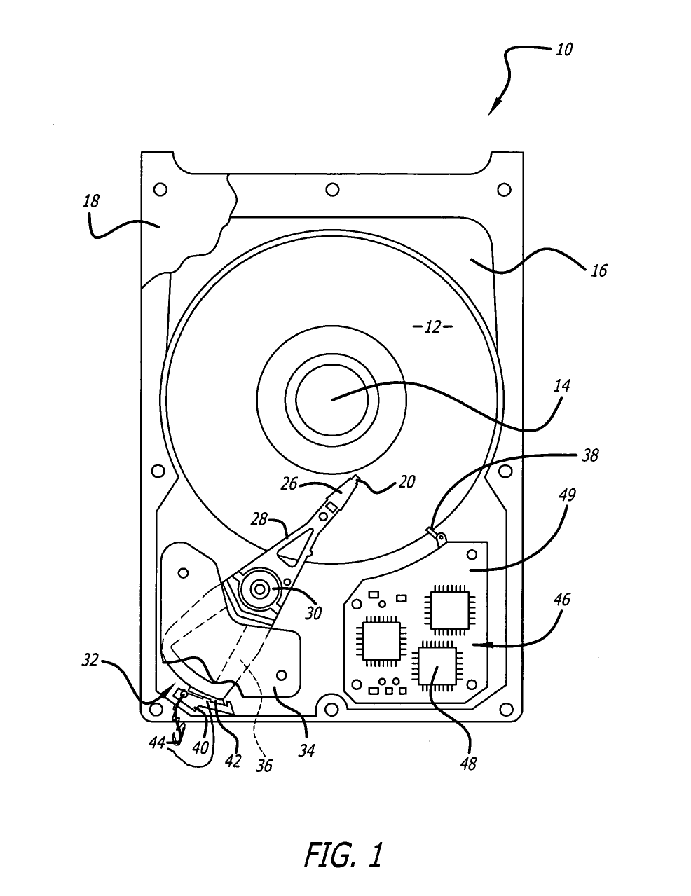

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a ramp 38 located adjacent to the outer diameter of the disks 12. The heads 20 can be loaded onto the ramp 38 when the drive is neither reading or writing information from the disks 12. The disk drive 10 may also have a latch 40 that engages a lip portion 42 of the actuator arm 28 to secure the arm 28. The latch 40 may have a crash stop 44 that limits the movement of the actuator arm 28. The actuator arm 28 typically engages the crash stop 44 during an off-disk routine to move the heads 20 onto the ramp 38.

The hard disk drive 10 may include a printed circuit board assembly 46 that includes a plurality of integrated circuits 48 coupled to a printed circuit board 49. The printed circuit board 49 is coupled to the voice coil 32, heads 20 and spindle motor 14 by wires and flexible circuits.

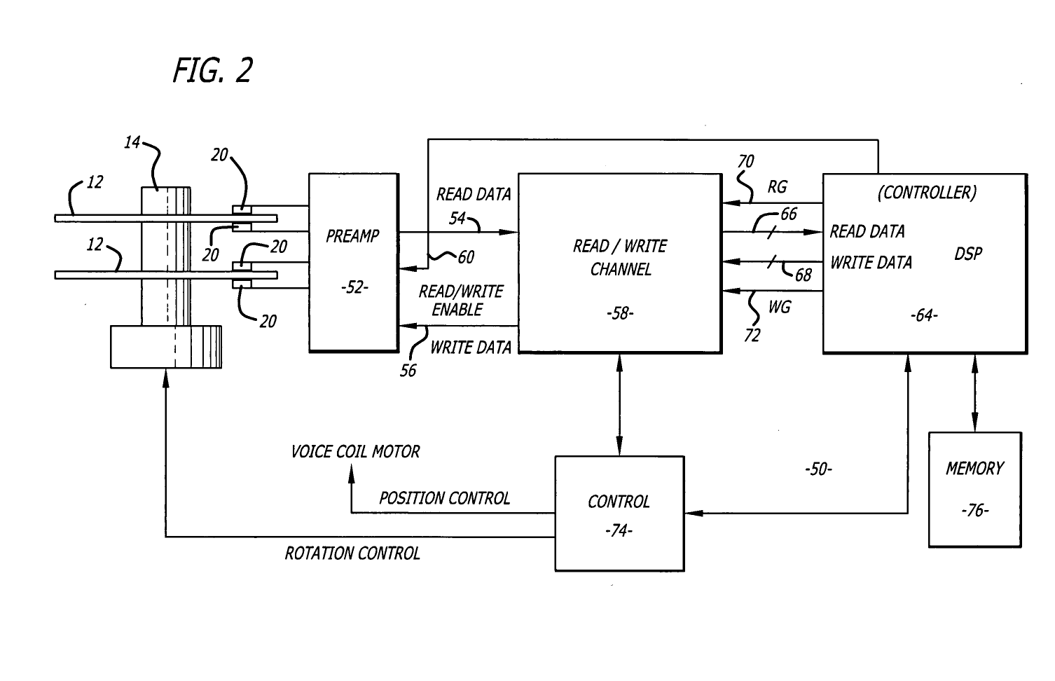

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine(s), including a routine(s) to write and read data from the disks 12. The read/write channel circuit 58 and controller 64 may also be connected to a control circuit 74 which controls the voice coil motor 36 and spindle motor 14 of the disk drive 10. The control circuit 74 may include circuitry to sense the back emf of the voice coil motor.

The controller 64 may be connected to a non-volatile memory device 76. By way of example, the device 76 may be a read only memory (“ROM”). The non-volatile memory 76 may contain the firmware and/or software routine(s) performed by the controller. By way of example, the firmware and/or software routine(s) may include an off-disk routine that is performed by the controller to move the heads 20 onto the ramp 38.

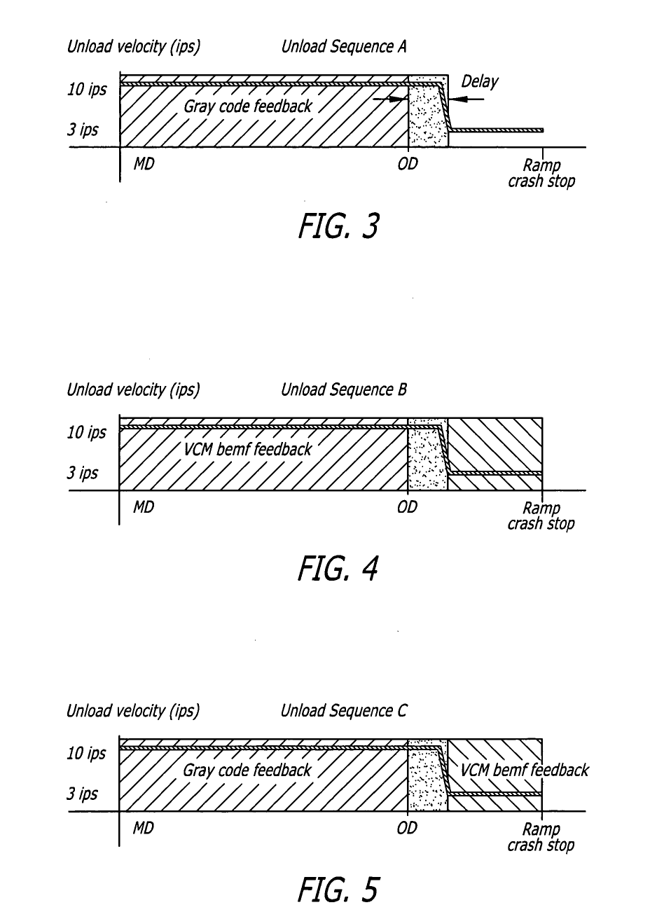

FIG. 3 is an illustration showing the movement of a head in one embodiment of an off-disk routine. By way of example, the disk drive may receive a power down command from a computer system, which causes the controller 64 to enter an off-disk routine to move the heads 20 onto the ramp 38. The routine may initially move the heads 20 to the middle diameter of the disks 12.

The controller may then cause the heads 20 to move from the middle diameter to the outer diameter of the disks 12. During this movement the heads 20 may read the Gray codes of the disks to determine head velocity. The process of reading Gray codes to determine head velocity may be the same or similar to the methods employed in a seek routine. The heads 20 may move across the disks 12 at a constant velocity. For example, the heads 20 may move at a rate of 10 inches per second.

When the heads reach beyond the outer tracks of the disks 20 the system is unable to receive Gray code information to track head velocity. The heads 20 move from the disks 20 and onto the ramp 38 during this period. After a time delay DELAY the heads 20 are decelerated. This can be accomplished by reversing the current to the voice coil motor and creating a braking torque on the VCM. Alternatively, the current provided to the voice coil motor may merely be reduced to slow down the speed of the heads 20. The heads 20 continue to move until the actuator arm 28 engages the crash stop 44. During the braking phase the speed of the heads is reduced to minimize the impact of the actuator arm 28 into the crash stop 44. By way of example, the heads 20 may have a speed of 3 inches per second when the arm 28 hits the stop 44. The time delay DELAY should be calculated to provide a proper transition from the first phase (head movement across the disk) to the second phase (head movement across the ramp). By way of example the time delay may be about 100 milliseconds for a routine that reduces head speed from 10 ips to 3 ips.

FIG. 4 shows another embodiment of an off-disk routine, wherein the disk drive senses the back emf of the voice coil motor during movement of the heads. The back emf can be used to determine the speed of head movement. Because this embodiment does not rely on Gray codes for feedback, head velocity can be controlled throughout the entire off-track routine. The back emf can be sensed by periodically opening the voice coil motor circuit. Alternatively, the back emf of the voice coil motor can be sensed even when the motor is energized with the equation:
back emf=V−IR (1)
Where;
V=the total voltage of the voice coil motor;
I=the current supplied to the voice coil motor;
R=the resistance of the voice coil.

FIG. 5 shows another embodiment of an off-disk routine where Gray codes are utilized to determine the velocity of the heads while traveling across the disks, and the back emf is used to sense head velocity when the heads are off of the disks.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A hard disk drive, comprising:
a housing;
a spindle motor coupled to said housing;
a disk coupled to said spindle motor, said disk having a middle diameter and an outer diameter;
an actuator arm coupled to said housing;
a head coupled to said actuator arm;
a voice coil motor coupled to said actuator arm;
a crash stop that makes contact with and impedes a movement of said actuator arm; and,
a control circuit that controls said voice coil motor to move said head from said middle diameter to said outer diameter of said disk and then decelerate movement of said head as said actuator arm.

2. The drive of claim 1, wherein said voice coil motor remains energized for a time interval after said head passes said outer diameter of said disk.

3. The drive of claim 1, further comprising a ramp that receives said head.

4. The drive of claim 3, wherein said head is decelerated while said head moves across said ramp.

5. The drive of claim 1, wherein movement of said head across said disk is controlled by reading a Gray code of said disk.

6. The drive of claim 1, wherein movement of said head across said disk is controlled by sensing a back emf of said voice coil motor.

7. The drive of claim 1, wherein movement of said head beyond said outer diameter of said disk is controlled by sensing a back emf of said voice coil motor.

8. The drive of claim 1, wherein said head is decelerated by applying a reverse current to said voice coil motor.

9. The drive of claim 5, wherein movement of said head beyond said outer diameter of said disk is controlled by sensing a back emf of said voice coil motor.

10. The drive of claim 2, wherein movement of said head across said disk is controlled by reading a Gray code of said disk.

11. The drive of claim 2, wherein movement of said head across said disk is controlled by sensing a back emf of said voice coil motor.

12. The drive of claim 10, wherein movement of said head beyond said outer diameter of said disk is controlled by sensing a back emf of said voice coil motor.

13. A hard disk drive, comprising:
a housing;
a spindle motor coupled to said housing;
a disk coupled to said spindle motor, said disk having a middle diameter and an outer diameter;
an actuator arm coupled to said housing;
a head coupled to said actuator arm;
a voice coil motor coupled to said actuator arm;
a crash stop that makes contact with and impedes a movement of said actuator arm; and,
control means for controlling said voice coil motor to move said head from said middle diameter to said outer diameter of said disk and then decelerate movement of said head as said actuator arm.

14. The drive of claim 13, wherein said voice coil motor remains energized for a time interval after said head passes said outer diameter of said disk.

15. The drive of claim 13, further comprising a ramp that receives said head.

16. The drive of claim 15, wherein said head is decelerated while said head moves across said ramp.

17. The drive of claim 13, wherein movement of said head across said disk is controlled by reading a Gray code of said disk.

18. The drive of claim 13, wherein movement of said head across said disk is controlled by sensing a back emf of said voice coil motor.

19. The drive of claim 13, wherein movement of said head beyond said outer diameter of said disk is controlled by sensing a back emf of said voice coil motor.

20. The drive of claim 13, wherein said head is decelerated by applying a reverse current to said voice coil motor.

21. The drive of claim 17, wherein movement of said head beyond said outer diameter of said disk is controlled by sensing a back emf of said voice coil motor.

22. The drive of claim 14, wherein movement of said head across said disk is controlled by reading a Gray code of said disk.

23. The drive of claim 14, wherein movement of said head across said disk is controlled by sensing a back emf of said voice coil motor.

24. The drive of claim 23, wherein movement of said head beyond said outer diameter of said disk is controlled by sensing a back emf of said voice coil motor.

25. A hard disk drive, comprising:
a housing;
a spindle motor coupled to said housing;
a disk coupled to said spindle motor, said disk having a middle diameter and an outer diameter;
an actuator arm coupled to said housing;
a head coupled to said actuator arm;
a voice coil motor coupled to said actuator arm;
a crash stop that makes contact with and impedes a movement of said actuator arm;
a controller coupled to said voice coil motor; and,
a memory that contains a program that causes said controller to control said voice coil motor to move said head from said middle diameter to said outer diameter of said disk and then decelerate movement of said head.

26. The drive of claim 25, wherein said voice coil motor remains energized for a time interval after said head passes said outer diameter of said disk.

27. The drive of claim 25, further comprising a ramp that receives said head.

28. The drive of claim 27, wherein said head is decelerated while said head moves across said ramp.

29. The drive of claim 25, wherein movement of said head across said disk is controlled by reading a Gray code of said disk.

30. The drive of claim 25, wherein movement of said head across said disk is controlled by sensing a back emf of said voice coil motor.

31. The drive of claim 25, wherein movement of said head beyond said outer diameter of said disk is controlled by sensing a back emf of said voice coil motor.

32. The drive of claim 25, wherein said head is decelerated by applying a reverse current to said voice coil motor.

33. The drive of claim 29, wherein movement of said head beyond said outer diameter of said disk is controlled by sensing a back emf of said voice coil motor.

34. The drive of claim 26, wherein movement of said head across said disk is controlled by reading a Gray code of said disk.

35. The drive of claim 26, wherein movement of said head across said disk is controlled by sensing a back emf of said voice coil motor.

36. The drive of claim 34, wherein movement of said head beyond said outer diameter of said disk is controlled by sensing a back emf of said voice coil motor.

37. A method for moving a head of a hard disk drive off of a disk, the head is coupled to an actuator arm, comprising:
moving the head from a middle diameter of the disk to an outer diameter of the disk; and,
decelerating the head as the actuator arm moves beyond the outer diameter of the disk.

38. The method of claim 37, wherein the head is moved with a voice coil motor and the voice coil motor remains energized for a time interval after the head passes the outer diameter of said disk.

39. The method of claim 37, wherein the head moves onto a ramp.

40. The method of claim 39, wherein the head is decelerated while the head moves across the ramp.

41. The method of claim 37, wherein movement of the head across the disk is controlled by reading a Gray code of the disk.

42. The method of claim 37, wherein movement of the head across the disk is controlled by sensing a back emf of the voice coil motor.

43. The method of claim 37, wherein movement of the head beyond the outer diameter of the disk is controlled by sensing a back emf of the voice coil motor.

44. The method of claim 37, wherein the head is decelerated by applying a reverse current to the voice coil motor.

45. The method of claim 41, wherein movement of the head beyond the outer diameter of the disk is controlled by sensing a back emf of the voice coil motor.

46. The method of claim 38, wherein movement of the head across the disk is controlled by reading a Gray code of the disk.

47. The method of claim 38, wherein movement of the head across the disk is controlled by sensing a back emf of the voice coil motor.

48. The method of claim 46, wherein movement of the head beyond the outer diameter of the disk is controlled by sensing a back emf of the voice coil motor.
